(19) United States
(12) Patent Application Publication
(10) Pub. No.: US 2023/0315776 A1
(43) Pub. Date: Oct. 5, 2023

(54) SYSTEM AND METHOD FOR DETECTING AND DELIVERING KEY MOMENTS DURING LIVE EVENTS

(71) Applicant: Buzzer Technologies Inc., New York, NY (US)

(72) Inventors: Kevin Martin, Miramar, FL (US); Rachel Warren, New York, NY (US); Tejas Priyadarshan, Oakland, CA (US); Dae Kang, New York, NY (US)

(21) Appl. No.: 18/191,560

(22) Filed: Mar. 28, 2023

Related U.S. Application Data
(60) Provisional application No. 63/324,853, filed on Mar. 29, 2022.

(51) Int. Cl. G06F 16/435; G06F 16/9536

(52) U.S. Cl. CPC G06F 16/435; G06F 16/9536

(57) ABSTRACT

A system includes: a memory unit adapted to store a user profile corresponding to each of a plurality of users, each user profile including user preference information; a communication unit, adapted to receive, via a telecommunications network, real-time or near real-time data relating to and during live events; and a processor adapted to analyze the received data, to detect an occurrence of an event during the live event based on analyzed data, to associate the detected occurrence of the event to each user according to the user preference information, and to communicate the occurrence of the event to each associated user. The processor is adapted to perform the analysis, the detection, the association, and the communication in real-time or near real-time during the live event.

### CROSS-REFERENCE TO RELATED APPLICATIONS

The present application claims the benefit of U.S. Provisional Patent Application Ser. No. 63/324,853, filed on Mar. 29, 2022, which is expressly incorporated herein in its entirety by reference thereto.

### FIELD OF THE INVENTION

The present invention relates to systems and methods for detecting and delivering key moments during live events.

### BACKGROUND INFORMATION

Live sports consumption is in decline due to a variety of factors, including the fragmented rights landscape, the proliferation of multiple live sports streaming services, and the lack of content awareness.

For publishers in the sports industry, for example, to send out details of key moments during live events, companies may have to hire dozens of employees to detect watchable moments and push out timely notifications to consumers. This unwieldy and expensive approach is difficult to implement, and makes it impossible to detect moments and deliver notifications in a timely and consistent manner.

Certain approaches may automate the moment detection and delivery process, but they largely focus on creating highlights after events are completed. These systems use crude markers, such as increased audio intensity levels, that do not always correlate to the moments consumers want to see. In addition, these systems still require human intervention to approve the clips for a final highlight

### SUMMARY

To address these and other perceived deficiencies, methods and systems are described herein that permit detection of moments and events during live sporting events and delivery of alerts relating to those events to users. Human bias and cognitive load may be decreased, while increasing speed, relevance, and accuracy of alert delivery to properly segmented users.

Certain aspects of the systems and methods described herein relate to predicting and detecting real-time or near-real-time moments during live events by leveraging in-game statistics, historical statistics, and live play-by-play data. For example, the systems and methods described herein may detect a moment or event during a live sporting event and deliver an alert within, e.g., 10 to 20 seconds, 5 to 10 second, 1 to 5 seconds, less than one second, etc., of the occurrence of the moment or event. Thus, a user of the system may receive instantaneous, substantially instantaneous, real-time, or near real-time alerts of moments or events.

These moments or events may include, but are not limited to, for example, a close game, a player milestone, or a team comeback, and may be delivered within seconds of detection. As noted above, the alert may be delivered within, e.g., 10 to 20 seconds, 5 to 10 second, 1 to 5 seconds, less than one second of detection. The system and method may improve the moment or even detection by utilizing machine learning algorithms, such as time series regression, to predict if and when a moment will occur during a live event. These machine learning algorithms may also detect unique moments based on milestones, events of interest, betting or fantasy slip data, specific players or teams. By including machine learning features, moment- or event-detection need not depend on pre-defined thresholds and the reason for a moment or event getting detected may vary over time.

The systems and methods described may provide for users to receive certain real-time or near real-time alerts based on their preferences and other known data points, such as location, user behavior, price point, time of day associated with consumption of sporting events, etc. For example, the system and method may determine the set of user(s)s that receive each alert based on the predicted probability of the user consuming the content relating to the alert. The system and method may increase the accuracy or relevance of the alerts issued to the user(s) based on personalization, machine learning techniques, such as content based recommendation engines with classifiers, that learn which alerts to send and when, based on both implicit and explicit user behavior. In doing so, alert fatigue may be reduced, and personalization may be increased.

According to example embodiments of the present invention, a system includes: a memory unit adapted to store a user profile corresponding to each of a plurality of users, each user profile including user preference information; a communication unit, adapted to receive, via a first telecommunications network, real-time or near real-time data relating to and during live events; and a processor adapted to analyze the received data, to detect an occurrence of an event during the live event based on the analyzed data, to associate the detected occurrence of the event to each user according to the user preference information, and to communicate, via a second telecommunications network, the occurrence of the event to each associated user. The processor is adapted to perform the analysis, the detection, the association, and the communication in real-time or near real-time during the live event.

According to example embodiments of the present invention, a method includes: receiving, by a communication unit via a first telecommunications network, real-time or near real-time data relating to and during live events; analyzing, by a processor, the data received by the communication unit; detecting, by the processor, an occurrence of an event during the live event based on the analyzed data; associating, by the processor, the detected occurrence of the event to each user of a plurality of users according to user preference information included in a user profile for each user stored in a memory unit; and communicating, by the processor via a second telecommunications network, the occurrence of the event to each associated user. The analyzing, the detecting, the associating, and the communicating are performed in real-time or near real-time during the live event.

According to example embodiments, the first telecommunications network and/or the second telecommunications network includes the internet.

According to example embodiments, the data includes audio data.

According to example embodiments, the data includes video data.

According to example embodiments, the data includes betting data.

According to example embodiments, the data includes social media data.

According to example embodiments, the live events include live sporting events.

According to example embodiments, the processor is adapted to detect the occurrence of the event based on a predetermined change of the data.

According to example embodiments, the processor is adapted to detect the occurrence of the event based on a predetermined rate of change of the data.

According to example embodiments, the processor is adapted to analyze amplitude and/or frequency of the audio data.

According to example embodiments, the processor is adapted to analyze the video data on a frame-by-frame basis.

According to example embodiments, wherein the processor is adapted to analyze hashtag data included in the social media data.

According to example embodiments, wherein the processor is adapted to analyze frequency of social media postings included in the social media data.

According to example embodiments, the communication unit is adapted to receive the data from a plurality of real-time or near real-time data sources.

According to example embodiments, the data includes multimedia data.

According to example embodiments, the processor is adapted to communicate the occurrence of the event to an electronic device corresponding to each associated user.

According to example embodiments, the electronic device includes a portable electronic device.

According to example embodiments, the communication unit is adapted to receive, from the electronic device via the second telecommunications network, a request from the associated user for video information relating to the detected occurrence of the event and to communicate, via the second telecommunications network, to the associated user in response to the request the video information.

According to example embodiments, the video information includes a video clip.

According to example embodiments, the video information includes a link to a video clip.

According to example embodiments, the detecting includes detecting, by the processor, the occurrence of the event based on a predetermined change of the data.

According to example embodiments, the detecting includes detecting, by the processor, the occurrence of the event based on a predetermined rate of change of the data.

According to example embodiments, the analyzing includes analyzing, by the processor, amplitude and/or frequency of the audio data.

According to example embodiments, the analyzing includes analyzing, by the processor, the video data on a frame-by-frame basis.

According to example embodiments, the analyzing includes analyzing, by the processor, hashtag data included in the social media data.

According to example embodiments, the analyzing includes analyzing, by the processor, frequency of social media postings included in the social media data.

According to example embodiments, the receiving includes receiving, by the communication unit, the data from a plurality of real-time or near real-time data sources.

According to example embodiments, the communicating includes communicating, by the processor, via the second telecommunications network, the occurrence of the event to an electronic device corresponding to each associated user.

According to example embodiments, the receiving includes receiving, by the communication unit, from the electronic device via the second telecommunications network, a request from the associated user for video information relating to the detected occurrence of the event and to communicate, via the second telecommunications network, to the associated user in response to the request the video information.

Further features and aspects of example embodiments of the present invention are described in more detail below with reference to the appended schematic Figures.

### BRIEF DESCRIPTION OF THE DRAWINGS

FIG. 1 schematically illustrates a system according to an example embodiment of the present invention.

FIG. 2 schematically illustrates detection process according to an example embodiment of the present invention.

FIG. 3 schematically illustrates social media activity and game point differential during the course of a particular game.

FIG. 4 further schematically illustrates social media activity and game point differential during the course of a particular game.

### DETAILED DESCRIPTION

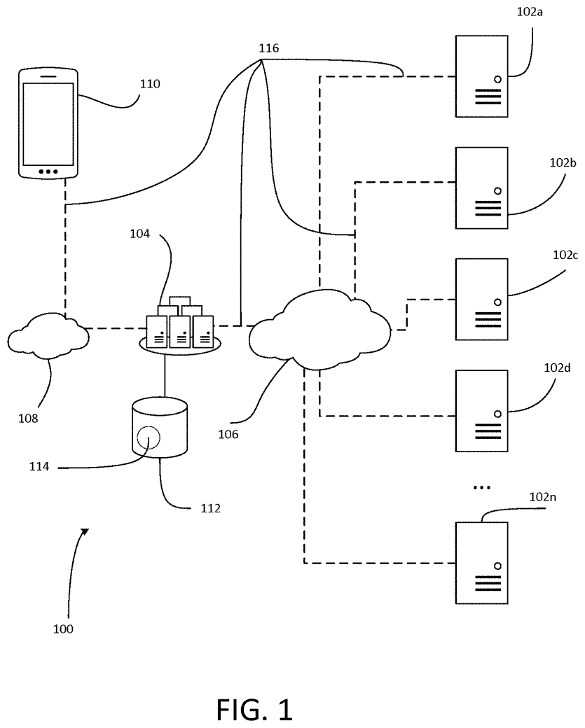

FIG. 1 schematically illustrates a system 100 according to an example embodiment of the present invention. The system 100 includes, for example, one or more sources 102a, 102b, 102c, 102d, . . . , 102n that communicate with a server 104. For example, one or more of the sources 102a to 102n may communicate with server 104 via a communication network 106. Network 106 may include a local network, a private network, a public network, the Internet, a wired network, a wireless network, a combination of mixed networks, etc. Server 104 may include one or more general purpose and/or special purpose computers adapted to perform the method described herein, and/or software 114 may be stored in a non-transitory computer readable storage medium 112, included in, in communication with, accessible by, and/or readable by server 104, as a set of instructions that are executable by a processor, e.g., one or more processor(s) included in server 104. The server 104 may include a single microprocessor-based computer device, may include multiple microprocessor-based computer devices, may include a distributed system, a centralized system, a server farm, a cloud-based system, etc. For example, the server 104 may include microprocessor(s), e.g., circuitry, adapted to execute the set of instructions stored in the non-transitory computer readable storage medium 112 to perform the processes described herein.

The system 100 includes, for example, electronic device(s) 110, arranged remote from server 104 and remote from sources 102a to 102n, in communication with server 104 via a network 108. Network 108 may include a local network, a private network, a public network, the Internet, a wired network, a wireless network, a combination of mixed networks, etc. For illustrative purposes only, FIG. 1 shows separate networks 106, 108. However, it should be understood that a single network may be provided for communication among components and subcomponents of system 100. Sources 102a to 102n may be connected to and communication with network 106 by communication lines 116.

Device(s) 110 may include, for example, a smartphone, e.g., an iPhone, an Android phone, etc., a tablet, e.g., an iPad, a Microsoft Surface tablet, a Fire tablet, etc., a smart home device, e.g., an Alexa device, an Echo device, a Google Assistant device, etc., a computer, a desktop computer, a laptop computer, a smart TV, an automotive entertainment device, a smart watch, a portable electronic device, a personal digital assistant, etc. Device 110 may communicate with server 104 wirelessly, e.g., via a Wi-fi network, a Bluetooth connection, a mobile/cellular telephone network, etc., and/or via a wired connection. Device 110 may be arranged as a dedicated device, e.g., adapted to operate exclusively in connection with the system and the method described herein, or as a general purpose device, e.g., adapted to operate in connection with a variety of systems, services, apps, etc.

Sources 102a to 102n may include real-time or near real-time sources of live information relating to, for example, sporting events, news events, live music events, television programming, weather events, etc. In connection with sporting events, sources 102a to 102n may include live sources, or feeds, of game data, including, for example, current scoring information, score differentials, game time remaining information, play-by-play information, location information, standings information, ranking information, game and/or player statistical information, state-of-play information, game streaks information, historical statistics, weather information, audio information, video information, team roster information, player information, player position information, betting data, including, for example, straight bet odds, prop bet odds, trending betting information, pre-game betting information, intra-game betting information, etc., social media information, e.g., tweets, retweets, posts, comments, likes, upvotes, dislikes, downvotes, shares, hashtag information, trending information, stories, etc., video stream information, including, for example, announcer audio information, stadium noise information, live play information, etc., sponsorship and partnership information, including, for example, ad impressions, ad views, promotional information, etc. Sources 102a to 102n communicate real-time or near real-time information to server 104 via network 106, and the real-time or near real-time information may be communicated from sources 102a to 102n as digital data streams.

Video information from one or more of source(s) 102a to 102n may include frame-by-frame data, e.g., at frame rates that may include industry standard frame rates, such as 24 FPS (Hz), 25 FPS, 50 FPS, 60 FPS, 120 FPS, 240 FPS, etc., at a variety of resolutions, e.g., standard definition or SD, also referred to as 480p, high definition or HD, also referred to as 720p, full HD or FHD, also referred to as 1080p, quad HD or QHD, also referred to as 1440p, 2K video, 4K video, ultra HD, or UHD, also referred to as 2160p, 8K video or full ultra HD, also referred to as 4320p, etc. Video information from one or more of source(s) 102a to 102n may be encoded according to a variety of video coding formats, such as, for example H.264, AVC, HEVC, AV1, VVC, H.266, etc. Audio information from one or more source(s) 102a to 102n may be encoded in an uncompressed format, e.g., WAV, AIFF, DSD, PCM, etc., a lossy compressed format, e.g., MP3, AAC, etc., a lossless compressed format, e.g., FLAC, ALAC, etc., at a variety of sampling rates, for example, in the range between, 8 and 192 kHz, e.g., 8, 16, 32, 44.1, 48 kHz, etc., at a variety of bit rates, for example, in the range between 8 and 1,536 kbits/s, e.g., 2, 8, 9.6, 24, 32, 40, 48, 56, 64, 80, 96, 128, 160, 292 kbits/s, etc., and at a variety of bits per sample, for example, between 8 and 32 bits per sample, e.g., 8, 16, 24, 32 bits per sample. The audio stream may be communicated between the source(s) 102a to 102n at a constant bit rate, a variable bit rate, etc. Video and/or audio information may be obtained by source(s) 102a to 102n directly from real-time sporting events. For example, source(s) 102a to 102n may feed licensed league content to server 104 in real time. As one example, source(s) 102a to 102n may feed broadcast video and/or audio information, e.g., soundboard audio, multicamera video, multiangle video, commentator video and/or audio, etc. As a further example, source(s) 102a to 102n may feed cable, satellite, and/or broadcast television signal(s), AM, FM, and/or satellite radio signal(s), subscriber video streaming information, etc., to server 104.

Betting information from one or more of source(s) 102a to 102n may include live, real-time, and/or near real-time data obtained from sportsbooks, bookmakers, betting parlors, online betting platforms, which, in turn, may be partnered with official sport leagues. Social media information from one or more of source(s) 102a to 102n may be obtained from social media networks, and game data from one or more of source(s) 102a to 102n may be obtained from official sports leagues. For example, source(s) 102a to 102n may communicate real-time or near real-time information obtained directly from official sources, e.g., through partnership, relationship, subscription, etc., with official sources, such as sports leagues, their licensees, etc.

Server 104 receives the real-time or near real-time data streams from the source(s) 102a to 102n, and analyzes and processes the received data, also in real-time or near real-time, to determine whether an event is occurring, and, if an event is occurring, communicates with the device(s) 110 to inform the user(s) of the event, in real-time or near real-time. For example, upon determination of that the event is occurring, the server 104 may transmit a push notification of the device 110, including audio information, video information, image information, score information, play information, commentator information, metadata, etc., and the device 110 may output an alert visually, audibly, tactilely, etc., to the user of the device 110. For example, the device 110 may prompt the user of the device 110 to play an audio and/or video clip, transmitted from the server 104 to the device 110, of the event. For example, the device 110 may prompt the user of the device 110 to stream an audio and/or video clip, transmitted from the server 104 to the device 110, of the event, by clicking on a link, virtual button, dialog box, icon, GUI element, notification, etc., presented visually, e.g., on a screen of the device 110, audibly, tactilely, haptically, etc.

The user of device 110 may provide server 104 with preference or interest information, e.g., follows followings, etc., specific to the user, for example, a favorite or preferred sports team or player, a favorite or preferred sports arena, stadium, or location, a favorite or preferred sport type, a favorite or preferred commentator, a favorite ore preferred team match-up, a favorite or preferred sports league, a favorite or preferred geographic area, etc., and the server 104 may include such preference or interest information in its analysis and process of the received data from the source(s) 102a to 102n in determining whether to alert the user of an event. Each user of system 100 may create a user profile, and the server 104 may associate the user profile with the corresponding user and device(s) 110 associated with the user, so that the server 104 will notify the user, via their associated device(s) 110, of event(s) based on the user's preferences and/or profile. Each user may have one or more associated device(s) 110.

For example, User 1's profile may include information that User 1's preferences include Teams A, B, and C, whereas User 2's profile may include information that User 2's preferences include Teams C, D and E. The server 104, upon determination or detection that an event relating to Team A is occurring, may push an alert to User 1's device(s) 110 of the event, so that User 1 is informed of the event and can watch and/or listen to the event in real-time or near real-time, whereas User 2 is not alerted of the event relating to Team A, since Team A is not stored in User 2's profile as a preferred or favorite team. The server 104, upon determination or detection that an event relating to Team D is occurring, may push an alert to User 2's device(s) 110 of the event, so that User 2 is informed of the event and can watch and/or listen to the event in real-time or near real-time, whereas User 1 is not alerted of the event relating to Team D, since Team D is not stored in User 1's profile as a preferred or favorite team. The server 104, upon determination or detection that an event relating to Team C is occurring, may push an alert to both User 1's device(s) 110 and User 2's device(s) of the event, so that User 1 and User 2 are both informed of the event and can watch and/or listen to the event in real-time or near real-time. The server 104, upon determination or detection that an event relating to Team F is occurring, may push an alert to neither User 1's device(s) 110 nor User 2's device(s) of the event, since Team F is not stored, e.g., by the user, in User 1's profile or User 2's profile as a preferred or favorite team. The server 104, for example, may be adapted to determine, from the user's profile, e.g., from the user's stated preferred or favorite teams, from the user's interaction with device(s) 110, from the user's search or browser history, from the user's social media profile, postings, engagements, followers, follows, etc., additional teams or topics that may be of interest, likely interest, or probably interest to the user. The server 104 may include or store such determined information in the user's profile, may make that information known or available to the user, or may maintain that information separate from the user's available profile information. In other words, the server 104 may determine, detect, or predict a user's leanings, preferences, tendencies without the user's own selection or identification thereof.

The server 104 may recommend additional preferences, interests, or favorites to the user's of device(s) 110 based on information contained in their profiles. For example, the server 104 may recommend to User 1, whose preferences include Teams A, B, and C, a direct rival of Teams A, B, and/or C, another team in User 1's geographic area, another sport having a team in the geographic area of Team A, B, and/or C, etc.

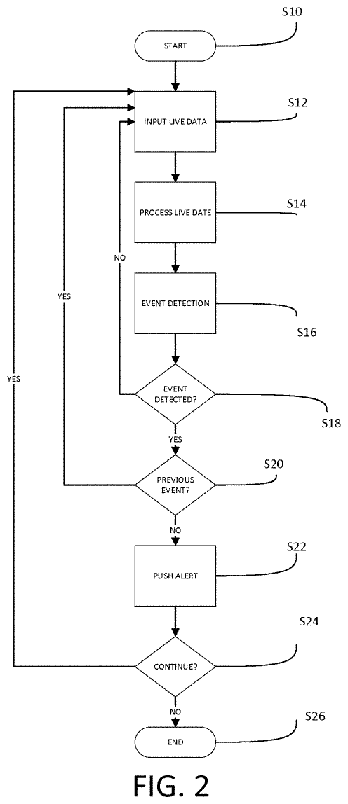

FIG. 2 illustrates a detection process according to an example embodiment of the present invention. The process starts at S10, which may correspond to, for example, the beginning of a live sporting event. During the live sporting event, real-time or near real-time data is obtained by the server 104 from source(s) 102a to 102n. For example, server 104 may ingest real-time or near real-time league content obtained from official or licensed league operators. Accordingly, in S12, live data is input to server 104 from source(s) 102a to 102n.

The live data is processed, in S14, by server 104. The processing may include, for example, filtering, deduplication, grouping, normalization, mean-centering, smoothing, windowing, time-over-time trend or variance analysis, and/or featurization. Video data, for example, may be processed on a frame-by-frame or other periodic basis, e.g., every other frame, every third frame, every fourth frame, every nth frame, etc., may be processed, successive groups of frames may be averaged and successively averaged frame groups may be processed, etc. Audio data may be processed on a sample-by-sample or other period basis, e.g., every other sample, every third sample, every fourth sample, every nth sample, etc., may be processed, successive groups of samples may be averaged and successively averaged sample groups may be processed, etc. The processed data is analyzed in S16 to detect, in real-time or near real-time, whether an event is occurring. For example, the analysis may include decision trees, change point detection, ARIMA (autoregressive integrated moving average) modeling, logistic regression, quantile regression, gradient boosting techniques, deep neural networks, deep learning techniques, etc., to determine whether an event is occurring. Video data may be processed using computer vision algorithms to detect crowding/commotion, general player movement for detection and prediction of fatigue, and identification of certain play setups and transitions. Video data may also be used to detect certain timely moments to trigger advertisements, either through on-the-fly commercial ad breaks or ad overlays on select surfaces across the court or field. For example, video data processed in S14 may be analyzed, in S16, e.g., on a frame-by-frame or other period basis, to determine player location, player movement, player proximity, team formation, team movement, ball position, e.g., relative to a tennis court's sideline(s), baseline(s), etc., a football field's end zone(s), sideline(s), goal line(s), goal position, etc., a baseball field's foul line(s), grass line(s), etc., a golf course's fairway(s), rough(s), fringe(s), trap(s), green(s), hazard(s), tee(s), hole(s), etc., a soccer field's touchline(s), goal line(s), goal area(s), etc., play call(s), penalty flag(s) or card(s), etc. Video data may be analyzed, e.g., decoded, over time to determine the extent or rate of change in movement of players, crowd, etc. For example, crowd movement may decrease significantly during a long field goal attempt, a possible home run event, or during a serve at match point, whereas crowd movement may increase significantly while a touch down is imminent, while a runner is stealing a base, etc. A predetermined increase or decrease, e.g., 25%, 15%, 10%, 5%, 1%, etc., change in video data or other trend in video data may indicate that a moment or event is occurring. Video data may be analyzed as described in Zhou et al., “Measuring Crowd Collectiveness,” IEEE Transactions on Pattern Analysis and Machine Intelligence, https://people.csail.mit.edu/bzhou/25 project/cvpr2013/pami.pdf, which is expressly incorporated herein in its entirety by reference thereto.

Audio data processed in S14 may be analyzed, in S16, to determine crowd noise, crowd silence, announcer or commentator volume, pitch, speed, intonation, comments, e.g., by speech recognition technique(s), etc. Audio data may be analyzed, e.g., decoded, by spectral decomposition to further focus on specific frequencies related to crowd chatter, announcer/commentators, and general game noise. The aforementioned algorithms and models may also be used to enhance sensitivity and specificity of audio source detection in real-time. For example, low-pass, high-pass, band-pass, etc. filtering may be performed on audio data to focus on certain frequency or frequency bands corresponding to crowd noise. Audio data, e.g., volume (amplitude), may be compared with predetermined threshold(s) to determine whether a moment or event is occurring, e.g., by exceeding a predetermined threshold, falling below a predetermined threshold, etc. Audio data may be analyzed over time to determine the change in pitch, volume, frequency, etc., of crowd noise. For example, crowd noise may decrease significantly during a long field goal attempt, a possible home run event, or during a serve at match point, whereas crowd movement may increase significantly while a touch down is imminent, while a runner is stealing a base, etc. A predetermined increase or decrease, e.g., 25%, 15%, 10%, 5%, 1%, etc., change in audio data or other trend in audio data may indicate that a moment or event is occurring. Audio data may be analyzed as described, for example, in Franzoni et al., “Emotional Sounds of Crowds: Spectrogram-Based Analysis using Deep Learning,” Multimedia Tools and Applications (2020), 79:36063-36075, http://doi.org/10.1007/s11042-020-09428-x (https://www.ncbi.nlm.nih.gov/pmc/articles/PMC7429201/pdf/11042_2020_Article_9428.pdf), which is expressly incorporated herein in its entirety by reference thereto.

Social media data processed in S14 may be analyzed, in S16, to determine trending posts, hashtags, tweets, retweets, quotes, content, attachment type, etc. Social media data may also be used to determine sports-adjacent attributes of the content (e.g., about a player but also about gaming, fashion, altruism, family, etc.), to further specify the type of content and allow for hyperpersonalization of moment delivery. Additionally, raw text from social media posts and comments may be leveraged in a detected moment through addition of sentiment and tone, to help further contextualize the moment. Different social platforms provide signals that differ due to engagement behavior(s) indicative of the demographics involved (young millennials vs. Gen X) and of general platform content/interactions. In this case, detection of meaningful moments may differ slightly across social platforms, so raw signals from these sources and how they are deconstructed and leveraged differs.

Betting data processed in S14 may be analyzed, in S16, to determine pre-game odds, intra-game odds, trending bets, etc. Data mining across different sports books provides an opportunity to surface moments based on choosing a platform with a bigger payout for the same bet. Analytically, betting data in concert with game data may be used to detect/predict alternating odds trends, to notify the user at the right moment to place or close out a bet. Combined with user interests, bets may be targeted to specific interests the user is likely to consume, which may then be positioned to graduate the user different bet types and potentially similar bet types across different sports. Surfacing moments or events through betting data may be performed through anomaly detection to detect when rare changes or swings in betting markets occur. Similarly, volatility analysis may be used to approximate uncertainty of future game outcomes, which may correlate with overall moment excitement and prospective consumption by sports fans. Generally, time series analyses may be employed to characterize and parse betting odds signals for the creation of meaningful betting moments and personalization to individual sports fans. Server 104 determines in S16, based on data processed by server 104 in S14, e.g., by analyzing the data itself, changes in the data, rates of change in the data, etc., whether heightened interest is occurring, whether significant change in the state of play is occurring, whether a significant moment, e.g., tying or breaking a previous record, an upset, a close game, an extended or overtime game, is occurring, etc. In other words, the server 104 determines, in S16, that an event is occurring based on the live data processed in S14.

In S18, upon detection, in S16, that no event is occurring, the process returns to S12 to continue ingesting and acquiring of real-time or near real-time data for further determination of event(s). Upon detection, in S16, that an event is occurring, the server 104 determines, in S20, whether a previous event has occurred in, for example, the same game, within a predetermined time of occurrence of a previous event in, for example, the same game, whether the same or a similar previous event has occurred, etc., to avoid or minimize transmitting excessive push alerts to the device(s) 110. The user of a device 110 may set preferences on the frequency that the user wishes to receive push alerts. For example, the user may set a preference to receive all push alerts relating to certain type of events, teams, players, etc., to receive less-frequent push alerts, e.g., once per game, once per quarter, half, or other game period, once per inning or other game interval, once per score event, etc. Upon determination, in S20, that the event detected in S18 constitutes a previous event, the process returns to S12 to continue ingesting and acquiring of real-time or near real-time data for further determination of event(s).

The server 104 also determines whether a determined event is of interest to any user of any of devices 110, e.g., based on the user's profile, preferences, favorites, follows, likes, etc., and, for each user interested in the determined moment, the server 104 transmits or pushes an alert to the user's respective device(s) 110. Alternatively and/or additionally, the server 104 may communicate an alert to a third-party's server(s) or systems(s) to instruct the third-party's server(s) or system(s) to publish, push, or communicate the alert in real-time or near real-time to the third-party's use(s) or subscriber(s). For example, the server 104 may communicate an alert to a social media platform's server(s) or system(s), e.g., as a tweet, posting, story, etc., to appear on the feed of the social media platform. The alert may include a link or deep link directly to the game (to minimize the steps required by the user to actually watch the game). After receiving a push alert, the device(s) 110 may signal to the corresponding user(s), by audible, visual, tactile, and/or haptic technique(s), that the determined event is occurring. Such a push alert may include multimedia information, including, for example, audio, video, still image(s), score information, an event summary, emoji, icon, team logo, league theme song, team anthem, etc. The device(s) 110 receiving a push alert from server 104 may be configured to automatically play or display the transmitted multimedia information, such as automatically playing a video of the moment. The device(s) 110 receiving a push alert from server 104 may require user interaction to acknowledge and play multimedia information associated with the push alert. For example, the device(s) 110 receiving a push alert from server 104 may issue a prompt, e.g., visually on the display of the device 110, that, when pressed or clicked, may cause the device 110 to retrieve multimedia information, to launch a viewer app to allow the user of device 110 to watch the event, re-watch the event, comment on the event, share the event, tweet, retweet, post, and/or repost the event, like and/or dislike the event, watch the live game or match in which the event occurred, etc.

After transmitting the push alert in S22, the server 104 determines whether to continue the process, e.g., during continued game play, or whether to discontinue the process, e.g., in response to the game ending. Upon determination that the process should continue, in S24, the process returns to S12 to continue ingesting and acquiring of real-time or near real-time data for further determination of event(s), whereas upon determination that the process should not continue, in S24, the process ends at S26. It should be appreciated that the process may end at any time, e.g., in response to the game ending. It should also be appreciated that the user of a device 110 may, e.g., upon receipt of a push alert, may opt out of receiving further alerts for a predetermined time period, e.g., a day, week, season, a game, etc.

The device 110 may indicate the alert to the user for a predetermined period of time after receipt of the push alert. For example, the device 110 may provide a visual notification for 0.5 s, 1 s, 5 s, 10 s, etc., after receipt of the push alert. The device 110 may indicate the alert to the user until the user has acknowledged, reacted to, canceled, cleared, etc., the alert. The server 104 may determine that the event has ended and transmit a command to the device 110 to clear or cease displaying the alert. For example, the server 104 may push an alert to the device 110 that a record-breaking attempt or game event is occurring, in which case the device 110 will alert the user of that event, and the server 104 may transmit a further signal to the device 110 to clear or cease displaying the alert, in response to the record-breaking attempt or game event succeeding or failing.

The server 104 may include machine-learning or model training features. For example, the server 104 may track user reaction to push alerts, issue additional push alerts similar to those that the user of a device 110 has reacted to, but issue fewer push alerts similar to those that the user of a device has not reacted to, has ignored, has canceled, had cleared, etc. The server 104 may track the days of the week or month, the times of the day, etc., during which the user of a device 110 reacts to, or does not react to, push alerts and may modify or adjust the push alert frequency accordingly. For example, the server 104 may determine that the user of the device 110 reacts to push alerts during weekend games or matches but does not react to weekday evening games or matches. Thus, the server 104 may push more alerts to the user during weekend games or matches and may push fewer, or no, alerts to the user during weekday evening games or matches.

Each device 110 in system 100 may include microprocessor(s) adapted to execute the set of instructions stored in a non-transitory computer readable storage medium to perform the processes described herein. For example, each device 110 may include an app or other program that is executed by microprocessor(s) included in the device 110. The user of each device 110 may have an associated account or profile, so that server 104 can deliver push alerts tailored to the user and their preferences, favorites, follows, etc. Upon creating an account or profile, the user may select their interest(s), e.g., teams, player, match-ups, stadiums/venues, etc. The server 104 may be configured to identify or suggest a user's interest, e.g., based on a user's behavior in watching, not watching, reacting to, not reacting to, etc., push alerts. The server 104 may access a user's account with a sports league, ticket sales platform, betting platform, TV or cable service provider, etc., to identify team(s), player(s), sport(s), etc., that might be of interest to the user and may issue push alerts to the user based thereon. The server 104 may track whether a user of a device 110 has watched an event associated with a push alert, may track the length of time that a user of a device 110 has watched an event associated with a push alert, may track the number of times that a user of a device 110 has rewatched an event associated with a push alert, etc., and may adjust or modify the pushing of an alert, the frequency of pushing alerts, etc. The server 104 may track the user's watching or listening to a game or match that is independent of a push alert and may adjust or modify the pushing of alerts accordingly. For example, while the profile of a user of a device 110 may indicate that the user follows Teams A, B, and C, the user may also watch or listen to games or matches involving Teams D and E. The server 104 may thus determine that the user's interests include Teams D and E and may thus push alerts to the user relating to Teams D and E, even though the user did not identify Teams D and E as those of interest to the user. Additionally, the server 104 may determine that the user of one device 110 watches events that the server 104 did not alert the user of that device 110 to, but may have alerted the user(s) of other device(s) 110 to. Thus, for example, the server 104 may push alerts to a user's device 110 based on the user's actual engagement, independent of the user's preferences or profile. The server 104 may access a user's social media accounts and activity and track a user's liking, disliking, sharing, posting, reposting, upvoting, downvoting, etc., relating to an event and may utilize the user's social media activity in determining whether to issue more, fewer, or the same amount of push alerts. Thus, the server 104 may determine the likelihood that a user will or will not engage with a particular alert, based on the user's prior engagements, behavior, preferences, etc. For example, the server 104 may train its push alert based on prior behavior of the user.

The server 104 may push advertising or other sponsored information to device(s) 110. The server 104 may track whether the user watched such advertising or sponsored content, whether the user watched the full content or only part of the content, whether the user muted the content, whether the user closed the content or the player of the content, whether the user engaged with the content, e.g., to clicked on a link included in the advertisement, whether the user participated in sponsored gamification, etc.

The server 104 may ingest or acquire real-time information from a plurality of source(s) 102a to 102n simultaneously and in real-time or near real-time. The server 104 may ingest or acquire information relating to a plurality of games, sporting events, sports, etc., simultaneously. The server 104 may ingest or acquire information relating to, for example, all games of a particular sport, season, tournament, etc. The server 104 may push alerts to user(s) of device(s) 110 relating to events, such as a close game, e.g., a game with a close score, a game entering overtime or extended play, a playoff or other significant game, series, or tournament, win probability, bet payout amount, crowdsourced pre-, intra-, or post-game excitement scoring or predictions, etc.

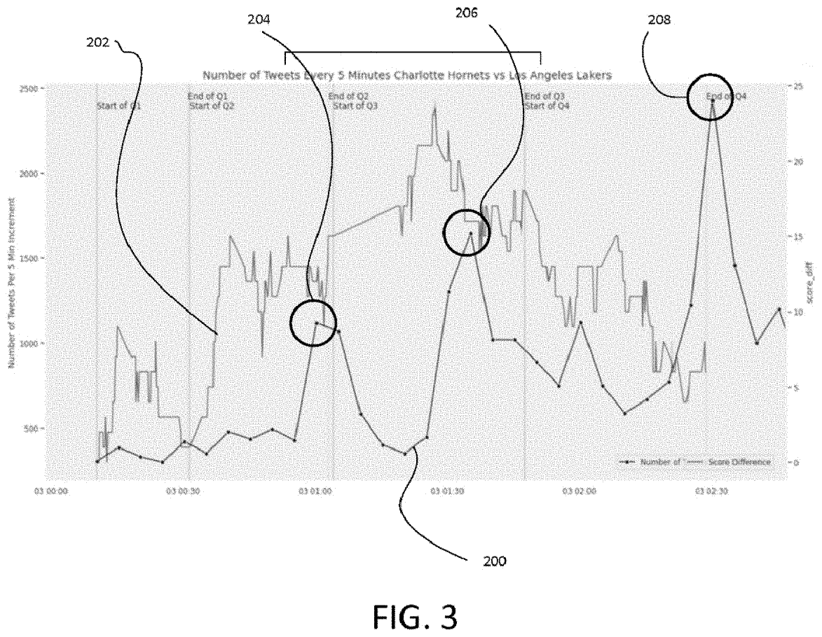

FIG. 3 illustrates social media activity and game point differential during the course of a particular game. For example, social media activity, ingested from one or more sources 102a to 102n, may include the number of posted tweets relating to the game. In FIG. 3, the abscissa represents game time, the left-hand ordinate represents the number of tweets per five minute interval, and the right-hand ordinate represents the score differential. As illustrated in FIG. 3, the number of tweets 200 relating to the game spiked 204 shortly before the end of the second quarter (first half), while the score differential 202 remained relatively constant, spiked again 206 as the game approached the end of the third quarter, shortly after the score differential 202 peaked, and spiked again 208 slightly after the end of the fourth quarter and the end of the same, after the score differential 202 dropped from its third quarter maximum. The server 104 may detect these spikes in social media activity and issue push alerts at the time, or shortly thereafter, e.g., under one minute, within 10 to 30 seconds, within 5 to 10 seconds, less than 5 seconds, etc., that the spikes 204, 206, 208 occur, which indicate events during the course of the game. It should be understood that the server 104 may issue push alerts based on one source 102a to 102n or based on aggregate data from a plurality of sources 102a to 102n.

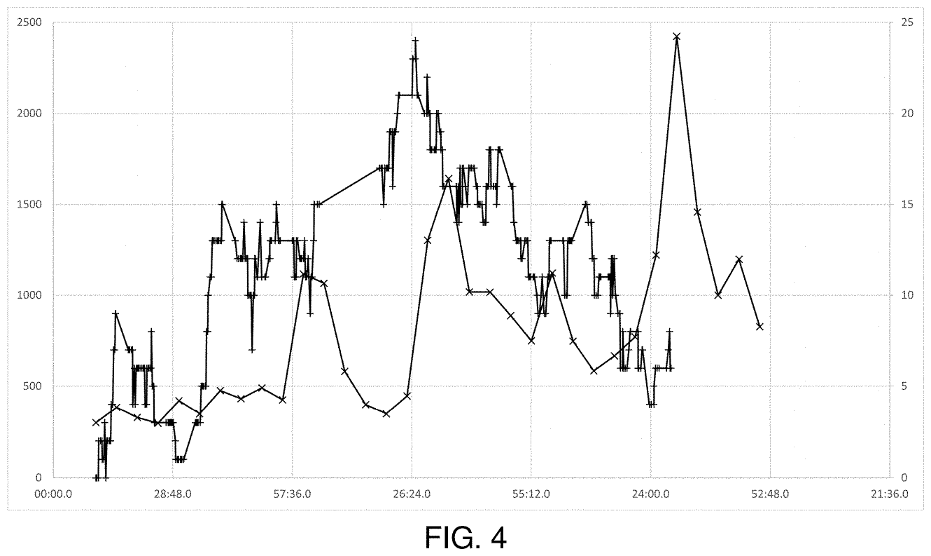

FIG. 4 further illustrates the social media activity and game point differential during the course of the game illustrated in FIG. 3. In FIG. 4, the abscissa represents game time, the left-hand ordinate represents the number of tweets per five minute interval (data series marked with the marker ‘x’), and the right-hand ordinate represents the score differential (data series marked with the marker ‘+’).

### LIST OF REFERENCE NUMERALS

100 System
102x
104 Server
106 Network/Internet
108 Network/Internet
110 Portable Electronic Device
112 Storage
114 Software
116 Communication Lines
200 Number of Tweets
202 Score Differential
204 Spike
206 Spike
208 Spike

What is claimed is:

1. A system, comprising:
a memory unit adapted to store a user profile corresponding to each of a plurality of users, each user profile including user preference information;
a communication unit, adapted to receive, via a first telecommunications network, real-time or near real-time data relating to and during live events; and
a processor adapted to analyze the received data, to detect an occurrence of an event during the live event based on the analyzed data, to associate the detected occurrence of the event to each user according to the user preference information, and to communicate, via a second telecommunications network, the occurrence of the event to each associated user;
wherein the processor is adapted to perform the analysis, the detection, the association, and the communication in real-time or near real-time during the live event.

2. The system according to claim 1, wherein the first telecommunications network and/or the second telecommunications network includes the internet.

3. The system according to claim 1, wherein the data includes audio data.

4. The system according to claim 1, wherein the data includes video data.

5. The system according to claim 1, wherein the data includes betting data.

6. The system according to claim 1, wherein the data includes social media data.

7. The system according to claim 1, wherein the live events include live sporting events.

8. The system according to claim 1, wherein the processor is adapted to detect the occurrence of the event based on a predetermined change of the data.

9. The system according to claim 1, wherein the processor is adapted to detect the occurrence of the event based on a predetermined rate of change of the data.

10. The system according to claim 3, wherein the processor is adapted to analyze amplitude and/or frequency of the audio data.

11. The system according to claim 4, wherein the processor is adapted to analyze the video data on a frame-by-frame basis.

12. The system according to claim 6, wherein the processor is adapted to analyze hashtag data included in the social media data.

13. The system according to claim 6, wherein the processor is adapted to analyze frequency of social media postings included in the social media data.

14. The system according to claim 1, wherein the communication unit is adapted to receive the data from a plurality of real-time or near real-time data sources.

15. The system according to claim 1, wherein the data includes multimedia data.

16. The system according to claim 1, wherein the processor is adapted to communicate the occurrence of the event to an electronic device corresponding to each associated user.

17. The system according to claim 16, wherein the electronic device includes a portable electronic device.

18. The system according to claim 16, wherein the communication unit is adapted to receive, from the electronic device via the second telecommunications network, a request from the associated user for video information relating to the detected occurrence of the event and to communicate, via the second telecommunications network, to the associated user in response to the request the video information.

19. The system according to claim 18, wherein the video information includes a video clip.

20. The system according to claim 18, wherein the video information includes a link to a video clip.

21. A method, comprising:
receiving, by a communication unit via a first telecommunications network, real-time or near real-time data relating to and during live events;
analyzing, by a processor, the data received by the communication unit;
detecting, by the processor, an occurrence of an event during the live event based on the analyzed data;
associating, by the processor, the detected occurrence of the event to each user of a plurality of users according to user preference information included in a user profile for each user stored in a memory unit; and
communicating, by the processor via a second telecommunications network, the occurrence of the event to each associated user;
wherein the analyzing, the detecting, the associating, and the communicating are performed in real-time or near real-time during the live event.

22. The method according to claim 21, wherein the first telecommunications network and/or the second telecommunications network includes the internet.

23. The method according to claim 21, wherein the data includes audio data.

24. The method according to claim 21, wherein the data includes video data.

25. The method according to claim 21, wherein the data includes betting data.

26. The method according to claim 21, wherein the data includes social media data.

27. The method according to claim 21, wherein the live events include live sporting events.

28. The method according to claim 21, wherein the detecting includes detecting, by the processor, the occurrence of the event based on a predetermined change of the data.

29. The method according to claim 21, wherein the detecting includes detecting, by the processor, the occurrence of the event based on a predetermined rate of change of the data.

30. The method according to claim 23, wherein the analyzing includes analyzing, by the processor, amplitude and/or frequency of the audio data.

31. The method according to claim 24, wherein the analyzing includes analyzing, by the processor, the video data on a frame-by-frame basis.

32. The method according to claim 26, wherein the analyzing includes analyzing, by the processor, hashtag data included in the social media data.

33. The method according to claim 26, wherein the analyzing includes analyzing, by the processor, frequency of social media postings included in the social media data.

34. The method according to claim 21, wherein the receiving includes receiving, by the communication unit, the data from a plurality of real-time or near real-time data sources.

35. The method according to claim 21, wherein the data includes multimedia data.

36. The method according to claim 21, wherein the communicating includes communicating, by the processor, via the second telecommunications network, the occurrence of the event to an electronic device corresponding to each associated user.

37. The method according to claim 36, wherein the electronic device includes a portable electronic device.

38. The method according to claim 36, wherein the receiving includes receiving, by the communication unit, from the electronic device via the second telecommunications network, a request from the associated user for video information relating to the detected occurrence of the event and to communicate, via the second telecommunications network, to the associated user in response to the request the video information.

39. The method according to claim 38, wherein the video information includes a video clip.

40. The method according to claim 38, wherein the video information includes a link to a video clip.
